(19) United States
(12) Patent Application Publication
(10) Pub. No.: US 2016/0286315 A1
(43) Pub. Date: Sep. 29, 2016

(54) SOUND PROCESSING APPARATUS, CROSSTALK CANCELING SYSTEM AND METHOD

(71) Applicant: HISENSE ELECTRIC CO., LTD., Qingdao (CN)

(72) Inventors: Chao ZHANG, Qingdao (CN); An WANG, Qingdao (CN); Weicai HUANG, Qingdao (CN); Shaowei LIU, Qingdao (CN)

(21) Appl. No.: 15/178,197

(22) Filed: Jun. 9, 2016

(30) Foreign Application Priority Data
Jun. 12, 2015 (CN) 201510324921.8

(51) Int. Cl. H04R 3/14; G06F 3/16

(52) U.S. Cl. CPC H04R 3/14; G06F 3/165; H04R 2430/03; H04R 2430/01

(57) ABSTRACT

The disclosure provides a crosstalk canceling system and method, and a sound processing apparatus, and the system includes: a sub-band filter component configured to frequency-divide an original audio signal transmitted over a sound channel of the multimedia device into sub-band signals, and to delay and apply gains to the sub-band signals according to preset delay values and gain values corresponding to the sub-band signals; a synthesizer configured to generate a crosstalk canceling signal from the sub-band signals which are delayed and to which the gains are applied; and a signal generator configured to generate a play signal of another sound channel than the sound channel from which the crosstalk canceling signal is derived, according to the crosstalk canceling signal, and an original audio signal of another sound channel than the sound channel from which the crosstalk canceling signal is derived, thus canceling crosstalk in effect.

### CROSS-REFERENCE TO RELATED APPLICATION

This application claims the benefit and priority of Chinese Patent Application No. 201510324921.8 filed Jun. 12, 2015. The entire disclosure of the above application is incorporated herein by reference.

### FIELD

The present disclosure relates to the field of audio processing, and particularly to a sound processing apparatus, a crosstalk canceling system and method.

### BACKGROUND

This section provides background information related to the present disclosure which is not necessarily prior art.

As illustrated in FIG. 1, if audio signals including stereo information are played using a left speaker 110 and a right speaker 111, then the phenomenon of crosstalk may occur between the respective speakers and the two ears, that is, sound played by the left speaker 110 may be heard by the right ear, and voice played by the right speaker 111 may be heard by the left ear. Particularly as illustrated in FIG. 1, if the audio signal A is transmitted from the left speaker 110, and the audio signal B is transmitted from the right speaker 111, then the audio signal A will arrive at the two ears of the listener 112 as signals A and A′ respectively, and alike, the audio signal B will arrive at the two ears of the listener 112 as signals B and B′ respectively, so that the sound heard by the respective ears of the listener 112 will be A+B′, and B+A′ respectively.

### SUMMARY

This section provides a general summary of the disclosure, and is not a comprehensive disclosure of its full scope or all of its features.

The disclosure provides a sound processing apparatus, a crosstalk canceling system and method, so as to cancel crosstalk.

The disclosure provides a sound processing apparatus including a plurality of speakers, the sound processing apparatus further includes:

at least one processor, and a memory in which at least one instruction executable by the at least one processor is stored, and the at least one instruction is configured, upon being executed by the at least one processor:

to frequency-divide an original audio signal transmitted over a sound channel of the sound processing apparatus into one or more sub-band signals, and to delay and apply gains to one or more the sub-band signals according to preset delay values and gain values corresponding to one or more the sub-band signals;

to generate the crosstalk canceling signal from one or more the sub-band signals which are delayed and to which the gains are applied;

to generate a play signal of another sound channel of the sound processing apparatus than the sound channel from which the crosstalk canceling signal is derived, according to the crosstalk canceling signal, and an original audio signal of the another sound channel than the sound channel from which the crosstalk canceling signal is derived; and

to output the play signal the speakers.

The disclosure provides a crosstalk canceling system applicable to a multimedia device, the crosstalk canceling system includes:

a sub-band filter component configured to frequency-divide an original audio signal transmitted over a sound channel of a multimedia device into one or more sub-band signals, and to delay and apply gains to one or more the sub-band signals according to preset delay values and gain values corresponding to the sub-band signals;

a synthesizer configured to generate a crosstalk canceling signal from one or more the sub-band signals which are delayed and to which the gains are applied; and

a signal generator configured to generate a play signal of another sound channel than the sound channel from which the crosstalk canceling signal is derived, according to the crosstalk canceling signal, and an original audio signal of the another sound channel than the sound channel from which the crosstalk canceling signal is derived.

The disclosure provides a crosstalk canceling method applicable to a multimedia device including a sound processing apparatus and a number of speakers, wherein the crosstalk canceling method includes:

frequency-dividing, by the sound processing apparatus, an original audio signal transmitted over a sound channel of the speakers into one or more sub-band signals of the original audio signal in the sound channel;

delaying and applying gains, by the sound processing apparatus, to one or more the sub-band signals according to preset delay values and gain values corresponding to one or more the sub-band signals; and

generating, by the sound processing apparatus, a crosstalk canceling signal of the sound channel from one or more the sub-band signals which are delayed and to which the gains are applied, and generating a play signal of another sound channel than the sound channel from which the crosstalk canceling signal is derived, according to the crosstalk canceling signal, and an original audio signal of the another sound channel than the sound channel from which the crosstalk canceling signal is derived.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of present disclosure.

FIG. 1 is a schematic diagram of the phenomenon of crosstalk in the prior art;

FIG. 2 is a schematic flow chart of a crosstalk canceling method according to an embodiment of the disclosure;

FIG. 3A is a schematic principle diagram of a crosstalk canceling method according to an embodiment of the disclosure;

FIG. 3B is a schematic diagram of a sub-band filter according to another embodiment of the disclosure;

FIG. 4 is a schematic structural diagram of a crosstalk canceling system according to a further embodiment of the disclosure;

FIG. 5 is a schematic structural diagram of a crosstalk canceling system according to a still further embodiment of the disclosure;

FIG. 6 is a schematic structural diagram of a crosstalk canceling system according to a yet further embodiment of the disclosure;

FIG. 7 is a schematic structural diagram of a crosstalk canceling system according to a still further embodiment of the disclosure; and

FIG. 8 is a schematic structural diagram of a sound processing apparatus according to an embodiment of the disclosure.

Corresponding reference numerals indicate corresponding parts or features throughout the several views of the drawings.

### DETAILED DESCRIPTION

Example embodiments will now be described more fully with reference to the accompanying drawings.

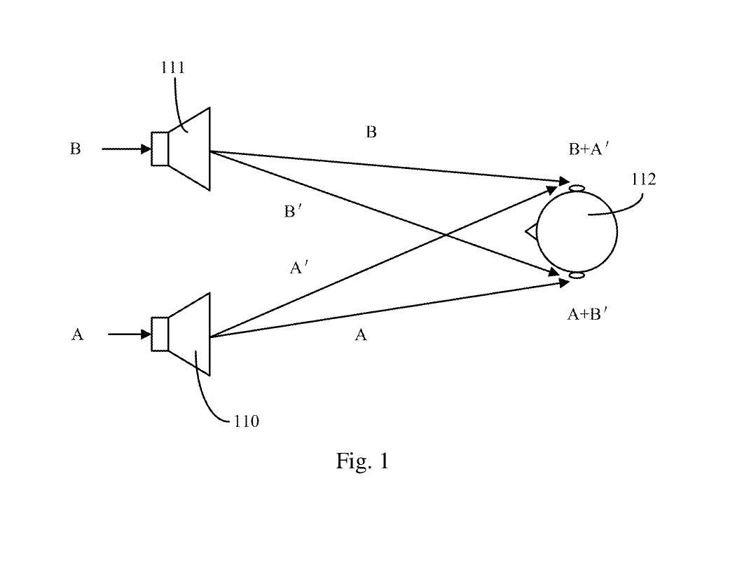

As illustrated in FIG. 1, if the audio signal A is transmitted from the left speaker 110, and the audio signal B is transmitted from the right speaker 111, then the audio signal A will arrive at the two ears of the listener 112 as signals A and A′ respectively, and alike, the audio signal B will arrive at the two ears of the listener 112 as signals B and B′ respectively, so that the sound heard by the respective ears of the listener 112 will be A+B′, and B+A′ respectively, that is, spatial position information received by the two ears is distorted so seriously that an expected virtual sound field cannot be reproduced, thus resulting in a significant loss of a 3D effect.

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

### First Embodiment

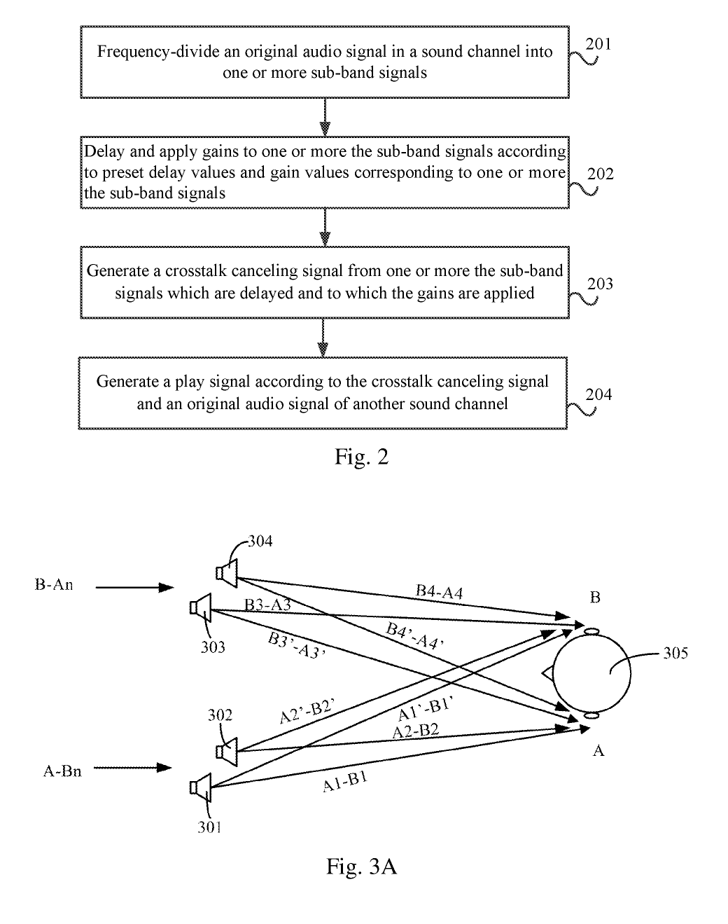

This embodiment provides a crosstalk canceling method so as to cancel crosstalk. An executor of this embodiment can be a crosstalk canceling system. FIG. 2 is a schematic flow chart of the crosstalk canceling method according to this embodiment.

The step 201 is to frequency-divide an original audio signal in a sound channel into one or more sub-band signals.

The crosstalk canceling system according to this embodiment can include a number of sound channels, e.g., two sound channels including a left sound channel and a right sound channel. One sound channel will be described by way of an example in this embodiment, and a sound source is configured to transmit the original audio signal over a corresponding sound channel from the sound source. It shall be noted that the original audio signal can be an all-frequency signal, or can be a signal in some audio frequency range, particularly as needed in reality, although the embodiment of the disclosure will not be limited thereto.

The original audio signal can be frequency-divided into a number of sub-band signals, or a part of the original audio signal can be picked out as a sub-band signal, particularly as needed in reality, although a repeated description thereof will be omitted here.

The step 202 is to delay and apply gains to one or more the sub-band signals according to preset delay values and gain values corresponding to one or more the sub-band signals.

In this embodiment, if there are a number of sub-band signals, then there will be delay values respectively corresponding to the respective sub-band signals in a one-to-one manner, and also gain values respectively corresponding to the respective sub-band signals in a one-to-one manner. Both the delay values and the gain values are preset.

Here a delay value of a sub-band signal of a sound channel represents a delay at which the sub-band signal arrives at one of the ears of a listener relative to the other ear; and a gain value of a sub-band signal of a sound channel represents a gain by which the sub-band signal arrives at one of the ears of a listener relative to the other ear.

The step 203 is to generate a crosstalk canceling signal from one or more the sub-band signals which are delayed and to which the gains are applied.

If there are a number of sub-band signals, then the crosstalk canceling signal can be generated from the sub-band signals which are delayed and to which the gains are applied, in this embodiment particularly in the following two approaches:

In a first approach, the sub-band signals which are delayed and to which the gains are applied are synthesized into the crosstalk canceling signal, that is, all the sub-band signals are synthesized into one crosstalk canceling signal.

In a second approach, the sub-band signals which are delayed and to which the gains are applied are determined as the crosstalk canceling signals, that is, there are a number of crosstalk canceling signals.

If there is only one sub-band signal, then the sub-band signal which is delayed and to which the gain is applied is the crosstalk canceling signal.

The step 204 is to generate a play signal, from the crosstalk canceling signal, and an original audio signal of another sound channel.

Particularly the play signal, corresponding to one or more the sub-band signals is generated from the crosstalk canceling signal, and signals in corresponding frequency bands in the original audio signal of the other sound channel, particularly as follows: the crosstalk canceling signal can be subtracted from the original audio signal of the other sound channel, for example, if an original audio signal transmitted from a left sound source is A, and an original audio signal transmitted from a right sound source is B; and the crosstalk canceling signal in this embodiment is Bn, then a play signal, generated by processing the original audio signal A in the crosstalk canceling method according to this embodiment will be A-Bn. A particular signal subtraction operation is known in the prior art, so a repeated description thereof will be omitted here.

In some embodiments of the disclosure, the crosstalk canceling signal can be further negatively correlated after the step 203 and before the step 204. For example, the crosstalk canceling signal can be inverted in the mathematical form of −Bn. A particular negative correlation operation is known in the prior art, so a repeated description thereof will be omitted here. Thus the play signal can alternatively be generated in the step 204 above by adding the original audio signal of the other sound channel to the negatively correlated crosstalk canceling signal (e.g., superimposing their waveforms on each other). A particular signal addition operation is known in the prior art, so a repeated description thereof will be omitted here.

In the crosstalk canceling method according to this embodiment, firstly the original audio signal is frequency-divided into one or more the sub-band signals, then the sub-band signals are delayed, and the gains are applied thereto, according to the delay values and the gain values corresponding thereto, and the crosstalk canceling signal is generated and further synthesized with the original audio signal of the other sound source into the play signal, and then the play signal is compensated for the crosstalk while being transmitted, and arrives at the ear of the listener as the original audio signal corresponding to the other sound channel, thus canceling the crosstalk in effect.

### Second Embodiment

The embodiment above will be further described in this embodiment. This embodiment will be described taking as an example the original audio signal which is an all-frequency signal, that is, the original audio signal includes mid-bass frequencies, and treble frequencies, where the original audio signal is frequency-divided, and delayed, and the gains are applied thereto, so that the crosstalk canceling signal is generated. The step 201 in the embodiment above will be described in further details in this embodiment.

In this embodiment, the original audio signal in the sound channel is frequency-divided into one or more the sub-band signals in the step 201 in the first embodiment as follows:

The original audio signal in the sound channel is frequency-divided into mid-bass frequency signals at mid-bass frequencies, and treble frequency signals at treble frequencies according to the mid-bass frequencies and the treble frequencies in the original audio signal.

Frequencies of the original audio signal in this embodiment includes the mid-bass frequencies and the treble frequencies, that is, the original audio signal includes the mid-bass frequency signals, and the treble frequency signals.

More particularly the step 201 in the first embodiment includes:

The mid-bass frequencies and the treble frequencies among the frequencies of the original audio signal of the sound channel are determined according to a preset frequency boundary between the mid-bass frequencies and the treble frequencies; and

A signal segment of the original audio signal corresponding to the mid-bass frequencies is divided into at least one mid-bass frequency signal, and a signal segment of the original audio signal corresponding to the treble frequencies is divided into at least one treble frequency signal.

That is, in this embodiment, the original audio signal is frequency-divided into the mid-bass frequency signals, and the treble frequency signals, both of which are sub-band signals, where the frequency boundary is a frequency at which the mid-bass frequency range are separated from the treble frequency range, and the frequency boundary can be preset as needed in reality. Given the frequency boundary, the mid-bass frequencies and the treble frequencies in the original audio signal can be determined. The mid-bass frequency signal segment can be divided into one or more sub-band signals, and alike the treble frequency signal segment can be divided into one or more sub-band signals.

Optionally there may be 4 to 8 sub-band signals at the treble frequencies, and also 4 to 8 sub-band signals at the mid-bass frequencies, so that there may be 8 to 16 sub-band signals in the crosstalk canceling system according to this embodiment. The number of sub-band signals is preset in such a range that the sub-band signals at the different frequencies can be delayed as separately as possible, and that the experience of a user can be avoided from being degraded by a long period of time for processing a too large number of sub-band signals.

More particularly there may be one delay value corresponding to each of the sub-band signals, and there are two different delay values among the respective delay values. For example, if the different speakers transmit their signals in different frequency bands, then if the signals in the different frequency bands lie in the frequency bands corresponding to the different speakers, then their corresponding delay values will be different from each other.

In this embodiment, there may be one or more delay values corresponding to the mid-bass frequency signals, particularly as needed in reality, and correspondingly there may be one or more delay values corresponding to the treble frequency signals, particularly as needed in reality, where the at least one delay value corresponding to the mid-bass frequency signals is different from the at least one delay value corresponding to the treble frequency signals.

Particularly the respective mid-bass frequency signals can be delayed according to the respective delay values corresponding to the respective mid-bass frequency signals; and further the respectively treble frequency signals can be delayed according to the respective delay values corresponding to the respective treble frequency signals.

In the crosstalk canceling method according to this embodiment, firstly the original audio signal of each sound channel is frequency-divided into the mid-bass frequency signals, and the treble frequency signals, and then the mid-bass frequency signals, and the treble frequency signals of each sound channel are delayed respectively so that the different frequency signals correspond to different delay values; and the crosstalk canceling signal is generated, and the crosstalk is canceled using the crosstalk canceling signal, so that even if the speakers arranged at different positions transmit the mid-bass frequency signals, and the treble frequency signals of the same sound channel respectively, the original audio signals corresponding to the respective ears of the listener will be heard by the two ears, thus canceling the crosstalk in effect.

### Third Embodiment

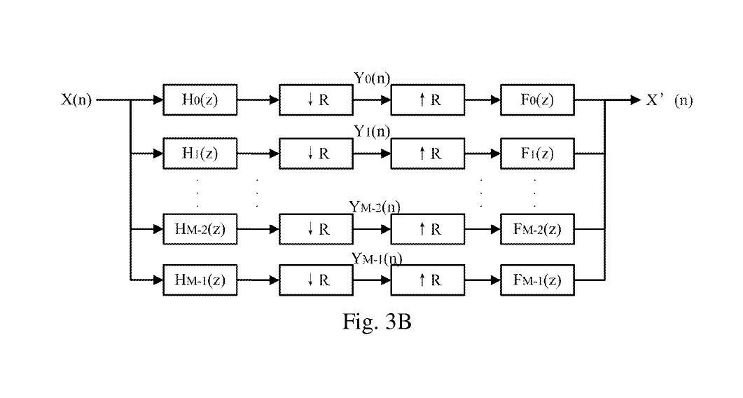

The embodiment above will be further described in this embodiment. As illustrated in FIG. 3A, if there are two sound channels in this embodiment, which correspond respectively to two sound sources including a left sound source and a right sound source, then the left sound source will correspond to the left sound channel, and the right sound source will correspond to the right sound channel. Each of the sound sources corresponds to two speakers, for example, the left sound source corresponds to a first left speaker 301 and a second left speaker 302, and the right sound source corresponds to a first right speaker 303 and a second right speaker 304, where the first left speaker 301 and the first right speaker 303 transmit sound downward as treble frequency signals, and the second left speaker 302 and the second right speaker 304 transmit sound backward as mid-bass frequency signals. The audio signals transmitted by the sound sources are original audio signals, i.e., signals to be really heard by a listener. The original audio signals of the left sound source and the right sound source may or may not be the same. “Downward” here refers to such a speaker that a sound transmitting port faces the ground, and “backward” refers to such a speaker that a sound transmitting port faces opposite to the listener.

If the original audio signal transmitted by the left sound source is A, and the original audio signal transmitted by the left sound source is B, then a play signal, generated by processing the original audio signal A in the crosstalk canceling method according to this embodiment will be A−Bn or A+(−Bn), where the original audio signal is frequency-divided by a frequency-dividing device (not illustrated) so that a signal played from the first left speaker 301 is a treble frequency signal A1−B1, and a signal played from the second left speaker 302 is a low frequency signal A2−B2, where A1−B1+A2−B2 is A−Bn or A+(−Bn). A play signal, generated by processing the original audio signal B in the crosstalk canceling method according to this embodiment will be B−An or B+(−An), where the original audio signal is frequency-divided by a frequency-dividing device (not illustrated) so that a signal played from the first right speaker 303 is a treble frequency signal B3−A3, and a signal played from the second right speaker 304 is a mid-bass frequency signal B4−A4, where B3−A3+B4−A4 is B−An or B+(−An). As can be apparent from FIG. 3A, the left ear of the listener 305 hears A1−B1+A2−B2+B3′−A3′+B4′−A4′, where Bn=B3′−A3′+B4′−A4′, and the right ear of the listener 305 hears B3−A3+B4−A4+A1′−B1′+A2′−B2′, where An=A1′−B1′+A2′−B2′. As a result, the audio signal A is heard by the left ear of the listener 305, and the audio signal B is heard by the right eye thereof, thus canceling the crosstalk.

Moreover in this embodiment, groups of sub-band signals can be frequency-divided and delayed, and gains can be applied thereto. For example, the original audio signals are transmitted respectively to respective sub-band filters of the groups of sub-band signals so that the sub-band filters frequency-divide, delay, and apply the gains to the original audio signal.

FIG. 3B illustrates a general structure of groups of sub-band filters, which is also referred to as groups of “analysis-integration” filters, where Hi(z) represents a group of analysis filters capable of processing frequency signals consecutive in sequence throughout the frequency band without any gap therebetween; and Fi(z) represents a group of integration filters, where ↓R and ↑R represent up- and down-samplers respectively configured to change a sampling rate. The sub-band filters operate in principle to frequency-divide an input signal X(n) by decomposing the signal into sub-band signals in different frequency bands, then processes the respective sub-band signals separately according to their characteristics, and finally recreates the signal from the respective processed sub-band signals. The signal X(n) in FIG. 3B is decomposed by the analysis filters Hi(z) into a series of sub-band signals, the sub-band signals are decimated by ↓R, delayed by delayers (not illustrated), and gainers (not illustrated), and then output, the output sub-band signals are interpolated by ↑R, and the respective delayed sub-band signals are synthesized by Fi(z) into a new signal. In this embodiment, both i and n range from 0 to M−1, where both i and n are positive integers, and M represents the number of sub-band filters.

Particularly the preset delay values and gain values corresponding to the respective sub-band filters can be derived experimentally. For example, an analyzer can be co-located with the listener, the original audio signal can be transmitted to the sub-band filters, and the delay values of the respective sub-band filters can be adjusted until the crosstalk is cancelled as indicated by the analyzer, and the respective delay values derived at this time can be determined as delay values corresponding to the respective sub-band filters, or the delay values corresponding to the respective sub-band filters can be determined by an expert. Particularly the expert firstly listens to the original audio signal played on an earphone, and then removes the earphone from his or her ears; and the expert stands facing the speakers at a distance of 2 to 2.5 meters from the speaker, compares the sound transmitted from the two speakers with the original audio signal played on the earphone for crosstalk, and if there is crosstalk, then the expert can determine empirically a frequency range of the crosstalk, and adjusts the delay values and the gain values of the respective sub-band filters until the expert determines that the crosstalk has been canceled, and the respective delay values derived at this time can be determined as delay values and gain values corresponding to the respective sub-band filters.

It shall be noted that the respective sub-band filters can process their audio ranges in the same span, for example, if there are 4 sub-band filters in a frequency range of 0 to 10 kHz, then the respective sub-band filters can process their audio ranges including 0 to 2500 Hz, 2500 to 5000 Hz, 5000 to 7500 Hz, and 7500 to 10000 Hz respectively.

The crosstalk canceling method according to this embodiment will be described below in details by way of an example.

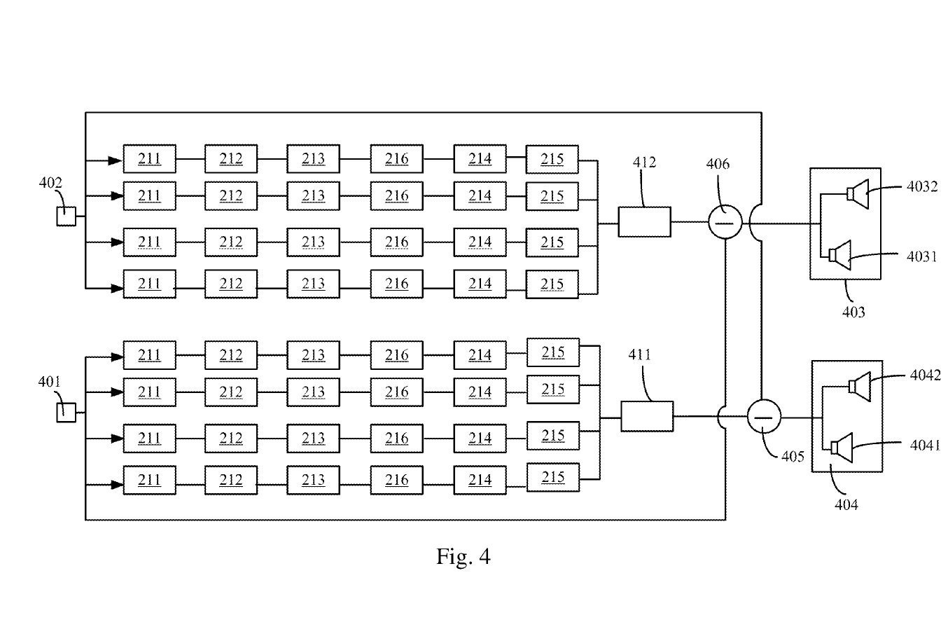

FIG. 4 illustrates a schematic structural diagram of a crosstalk canceling system including two sound sources which are a left sound source 401 and a right sound source 402 corresponding respectively to a left sound channel and a right sound channel. The left sound source 401 corresponds to a left sound box 403 in which a first left speaker 4031 and a second left speaker 4032 are arranged differently in position; and the right sound source 402 corresponds to a right sound box 404 in which a first right speaker 4041 and a second right speaker 4042 are arranged differently in position. A number of sub-band filters are arranged so that the respective sub-band filters corresponding to the left sound box 403 are connected with a left synthesizer 411 connected with a left subtracter 405 connected with a frequency-dividing device (not illustrated) of the right sound box 404; and alike the respective sub-band filters corresponding to the right sound box 404 are connected with a right synthesizer 412 connected with a right subtracter 406 connected with a frequency-dividing device (not illustrated) of the left sound box 403.

In this embodiment, if there are 8 sub-band filters, for example, including 4 sub-band filters corresponding to the left sound box 403, and 4 sub-band filters corresponding to the right sound box 404, then each of the sub-band filters will correspond respectively to one of sub-band signals, thus resulting in 8 sub-band signals in this embodiment. The respective speakers are connected with the frequency-dividing device.

Here the respective sub-band filters include analysis filters 211, up-samplers 212 connected with the analysis filters 211, delay processors 213 connected with the up-samplers 212, gain processors 216 connected with the delay processors 213, down-samplers 214 connected with the gain processors 216, and integration filters 215 connected with the down-samplers 214, as illustrated in FIG. 4.

If there is a frequency boundary at 2500 Hz in this embodiment, that is, mid-bass frequencies include 0 to 2500 Hz, and treble frequencies include 2500 Hz to 10 kHz, then the mid-bass frequencies will be separated from the treble frequencies so that a mid-bass frequency signal segment is divided by one sub-band filter into one sub-band signal at the frequencies of 0 to 2500 Hz Alike a treble frequency signal segment is divided by 3 sub-band filters into 3 sub-band signals respectively at 2500 to 5000 Hz, 5000 to 7500 Hz, and 7500 to 10000 Hz. That is, the respective sub-band filters can process their signals respectively in the frequency ranges of 0 to 2500 Hz, 2500 to 5000 Hz, 5000 to 7500 Hz, and 7500 to 10000 Hz.

Taking as an example, an original audio signal transmitted from the left sound source 401, the original audio signal is transmitted respectively to the respective sub-band filters, so that the analysis filters 211 in the respective sub-band filters filter the original audio signal, and generate sub-band signals, and the up-samplers 212 decimate the sub-band signals, then the delay processors 213 delay the respective decimated sub-band signals according to preset delay values corresponding to the delay processors, and also the respective gain processors 216 can apply gains to the respective sub-band signals according to preset gain values corresponding to the gain processors; and the sub-band signals pass the down-samplers 214, and the integration filters 215 interpolate the respective down-sampled sub-band signals to create new sub-band signals. The sub-band signals interpolated by the respective integration filters 215 are transmitted to the left synthesizer 411, and the left synthesizer 411 synthesizes the respective sub-band signals corresponding to the left sound channel, and generates and transmits a crosstalk canceling signal to the left subtracter 405.

By way of an example, the delay values and the gain values corresponding to the respective sub-band filters in the left speaker in this embodiment can be as depicted in Table 1:

TABLE 1

| | | |
|---|---|---|
| Audio ranges which can be | Delay | Gain |
| processed by sub-band filters | values | values |

| | | | |
|---|---|---|---|
| 0-2500 | Hz | 32 ms | 0.25 |
| 2500-5000 | Hz | 28 ms | 0.20 |
| 5000-7500 | Hz | 16 ms | 0.33 |
| 7500-10000 | Hz | 14 ms | 0.36 |

The left subtracter 405 subtracts the crosstalk canceling signal from an original audio signal of the right sound source 402, and generates and transmits a play signal, to the frequency-dividing device in the right sound box 404, and the right sound box frequency-divides the signal, and then transmits mid-bass frequency signals and treble frequency signals respectively through the second right speaker and the first right speaker, so that a sound signal arriving at the right ear of the listener is the original audio signal of the right sound source 402.

Alike the original audio signal of the right sound source 402 are decimated and delayed, gains will be applied thereto, and it will be interpolated, similarly to the original audio signal of the left sound source 402, so that a crosstalk canceling signal is generated and subtracted from the original audio signal corresponding to the left sound source 402, a play signal is generated and transmitted to the frequency-dividing device in the left sound box 403, and the left sound box frequency-divides the signal, and then transmits mid-bass frequency signals and treble frequency signals respectively through the second left speaker and the first left speaker, so that a sound signal arriving at the right left of the listener is the original audio signal of the left sound source 401.

The delay values and the gain values corresponding to the respective sub-band filters in the right speaker in this embodiment can be as depicted in Table 1.

In this embodiment, both the left ear and the right ear of the listener can hear the original audio signals of the sound sources at the corresponding sides.

In the crosstalk canceling method according to this embodiment, firstly the original audio signal of each sound channel is frequency-divided into the mid-bass frequency signals, and the treble frequency signals, then the mid-bass frequency signals, and the treble frequency signals in each sound channel are delayed respectively so that the different frequency signals correspond to the different delay values, the crosstalk canceling signal is generated and further synthesized with the original audio signal of the other sound channel, the mid-bass frequency signals, and the treble frequency signals of the same sound channel are transmitted through the differently positioned speakers, and then the crosstalk is compensated for, so that the two ears of the listener hear the original audio signals corresponding to the respective ears, thus canceling the crosstalk in effect.

### Fourth Embodiment

This embodiment provides a crosstalk canceling system for performing the crosstalk canceling method according to the first embodiment. This embodiment addresses how to generate a crosstalk canceling signal, and how to generate a play signal, from the crosstalk canceling signal, so that the play signal, arriving at the respective ear of a listener is compensated for cross-talk to thereby enable the respective ear of the listener to hear an original audio signal of some sound channel.

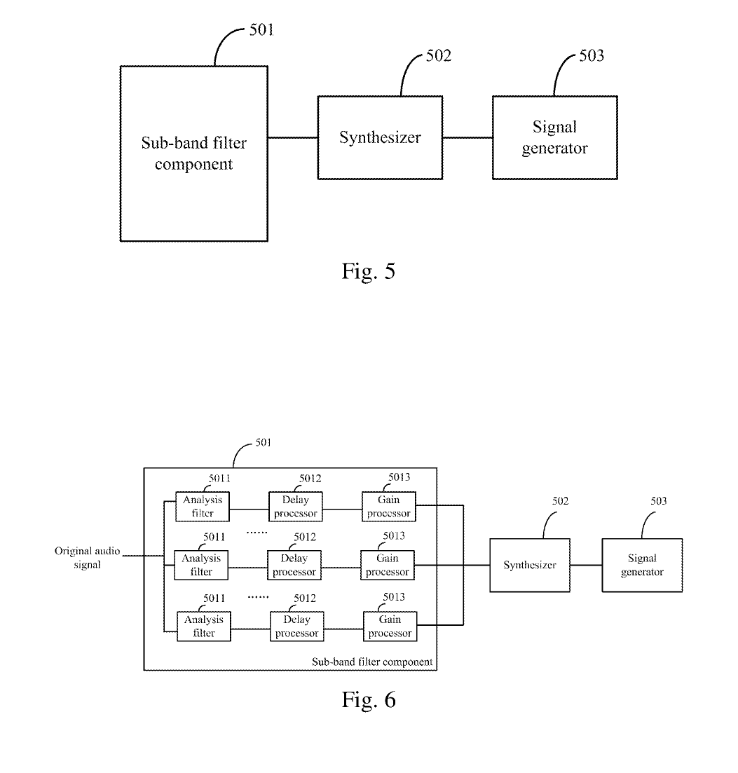

FIG. 5 is a schematic structural diagram of a crosstalk canceling system according to this embodiment. As illustrated in FIG. 5, the crosstalk canceling system according to this embodiment includes a sub-band filter component 501, a synthesizer 502, and a signal generator 503, where sub-band filter unit 501 is configured to frequency-divide an original audio signal transmitted over a sound channel into one or more sub-band signals, and to delay and apply gains to one or more the sub-band signals according to preset delay values and gain values corresponding to one or more the sub-band signals; the synthesizer 502 connected with the sub-band filter component 501 is configured to generate a crosstalk canceling signal from one or more the sub-band signals which are delayed and to which the gains are applied; and the signal generator 503 connected with the synthesizer 502 is configured to synthesize the crosstalk canceling signal with an original audio signal of another sound channel into a play signal of the other sound channel.

It shall be noted that the crosstalk canceling system according to this embodiment may alternatively not include the synthesizers 502, where the sub-band filter component 501 is configured to frequency-divide an original audio signal transmitted over a sound channel into one or more sub-band signals, and to delay and apply gains to one or more the sub-band signals according to preset delay values and gain values corresponding to one or more the sub-band signals; and the signal generator 503 connected with the sub-band filter component 501 is configured to synthesize one or more the sub-band signals which are delayed and to which the gains are applied, with an original audio signal of another sound channel into a play signal of the other sound channel.

Optionally the sub-band filter component 501 includes a number of sub-band filters with the corresponding delay values, at least two of which are different from each other; and the synthesizer 502 is configured:

To synthesize one or more the sub-band signals which are delayed and to which the gains are applied, into the crosstalk canceling signal. Moreover the synthesizer 502 can be further configured to negatively correlate the generated crosstalk canceling signal.

Optionally the signal generator 503 in this embodiment is configured:

To generate the play signal of the other sound channel, corresponding to one or more the sub-band signals from the crosstalk canceling signal, and signals at corresponding frequency bands in the original audio signal of the other sound channel, and particularly to superimpose the negatively correlated crosstalk canceling signal onto the original audio signal of the other sound channel than the sound channel from which the crosstalk canceling signal is derived, to obtain the play signal of the other sound channel than the sound channel from which the crosstalk canceling signal is derived, or to subtract the crosstalk canceling signal from the original audio signal of the other sound channel than the sound channel from which the crosstalk canceling signal is derived, to obtain the play signal of the other sound channel than the sound channel from which the crosstalk canceling signal is derived (where the signal generator can be a subtracter).

The crosstalk canceling system according to this embodiment will be operated in the same method as the first embodiment, so a repeated description thereof will be omitted here.

In the crosstalk canceling system according to this embodiment, the original audio signal is frequency-divided by the sub-band filter component 501 into one or more the sub-band signals, then one or more the sub-band signals are delayed, and the gains are applied thereto, according to the delay values and the gain values corresponding to one or more the sub-band signals, the crosstalk canceling signal is generated by the synthesizers 502, and further synthesized by the signal generator 504 with the original audio signal of the other channel, and then the play signal is compensated for the crosstalk, so that the original audio signal corresponding to the other sound channel is heard by the respective ear of the listener, thus canceling the crosstalk in effect.

### Fifth Embodiment

The crosstalk canceling system according to the embodiment above will be further described in this embodiment. This embodiment will be described taking as an example the original audio signal which is an all-frequency signal, that is, the original audio signal includes mid-bass frequencies, and treble frequencies, where the original audio signal is frequency-divided, and delayed, and the gains are applied thereto, so that the crosstalk canceling signal is generated. There are a number of sub-band signals in this embodiment. This embodiment will be described particularly with respect to the sub-band filter component in the crosstalk canceling system according to the embodiment above.

As illustrated in FIG. 6, the sub-band filter component 501 in the crosstalk canceling system according to this embodiment includes a number of sub-band filters, each of which includes an analysis filter 5011, a delay processor 5012, and a gain processor 5013.

Here the analysis filters 5011 are configured to frequency-divide the original audio signal into mid-bass frequency signals at mid-bass frequencies, and treble frequency signals at treble frequencies according to the mid-bass frequencies and the treble frequencies in the original audio signal; the delay processors 5012 connected with the analysis filters 5011 are configured to delay the mid-bass frequency signals according to delay values corresponding to the mid-bass frequencies, and the treble frequency signals according to delay values corresponding to the treble frequencies; and the gain processors 5013 connected with the delay processors 5012 are configured to apply gains to the mid-bass frequency signals according to gain values corresponding to the mid-bass frequencies, and gains to the treble frequency signals according to gain values corresponding to the treble frequencies.

The number of sub-band filters corresponding to one sound channel in this embodiment can range from 4 to 8, and the number of sub-band filters is preset in such a range that the sub-band signals at the different frequencies can be delayed as separately as possible, and that the experience of a user can be avoided from being degraded by a long period of time for processing a too large number of sub-band signals.

Optionally the analysis filters 5011 in this embodiment are configured:

To determine the mid-bass frequencies and the treble frequencies among the frequencies of the original audio signal of the sound channel according to a preset frequency boundary between the mid-bass frequencies and the treble frequencies; and

To divide a signal segment of the original audio signal corresponding to the mid-bass frequencies into at least one mid-bass frequency signal, and a signal segment of the original audio signal corresponding to the treble frequencies into at least one treble frequency signal.

The crosstalk canceling system according to this embodiment will be operated in the same method as the first embodiment, so a repeated description thereof will be omitted here.

In the crosstalk canceling system according to this embodiment, firstly the original audio signal of each sound channel is frequency-divided by the respective sub-band filters into the respective sub-band signals, then the respective sub-band signals are delayed, the crosstalk canceling signal is generated and further synthesized with the original audio signal of the other sound channel, and then the play signal is compensated for the crosstalk, so that the original audio signal of the other sound channel is heard by the respective ear of the listener, thus canceling the crosstalk in effect.

### Sixth Embodiment

This embodiment provides a crosstalk canceling system for performing the crosstalk canceling method according to the first embodiment. This embodiment addresses how to generate a crosstalk canceling signal, and how to generate a play signal, from the crosstalk canceling signal, so that the play signal, arriving at the respective ear of a listener is compensated for cross-talk to thereby enable the respective ear of the listener to hear an original audio signal of some sound channel.

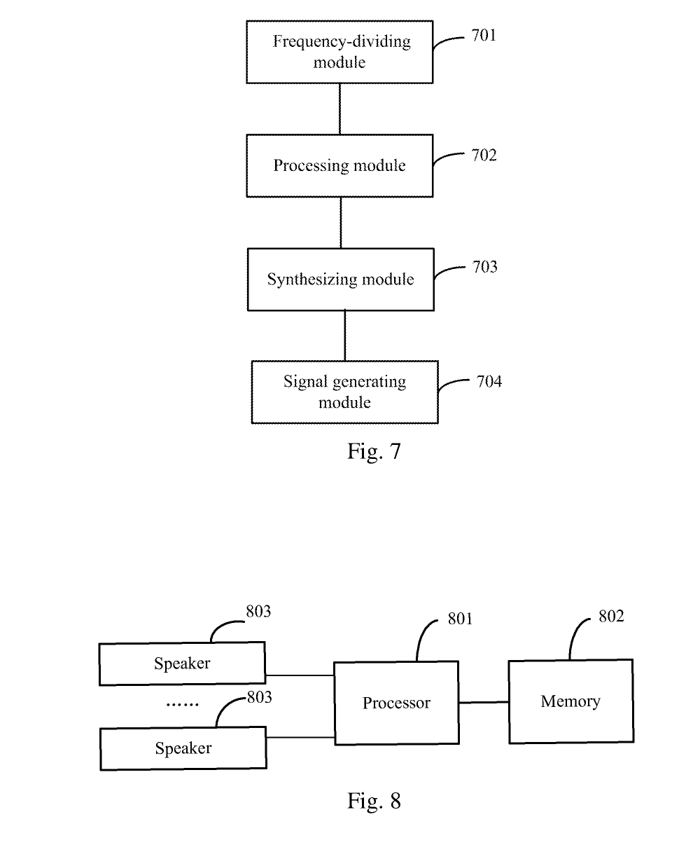

FIG. 7 is a schematic structural diagram of a crosstalk canceling system according to this embodiment. As illustrated in FIG. 7, the crosstalk canceling system according to this embodiment includes a frequency-dividing module 701, a processing module 702, an synthesizing module 703, and a signal generating module 704, where the frequency-dividing module 701 is configured to frequency-divide an original audio signal in a sound channel into one or more sub-band signals; the processing module 702 is configured to delay and apply gains to one or more the sub-band signals according to delay values and gain values corresponding to one or more the sub-band signals; the synthesizing module 703 is configured to generate a crosstalk canceling signal from one or more the sub-band signals which are delayed and to which the gains are applied; and the signal generating module 704 are configured to synthesize the crosstalk canceling signal with an original audio signal of another sound channel into a play signal of the other sound channel.

Optionally in this embodiment, there are a number of sub-band signals with the corresponding delay values, at least two of which are different from each other; and the synthesizing module 703 in this embodiment can be configured:

To synthesize the sub-band signals which are delayed and to which the gains are applied, into the crosstalk canceling signal. Moreover the synthesizing module 703 can be further configured to negatively correlate the generated crosstalk canceling signal.

Optionally the signal generating module 705 in this embodiment is configured:

To generate the play signal of the other sound channel, corresponding to one or more the sub-band signals from the crosstalk canceling signal, and signals at corresponding frequency bands in the original audio signal of the other sound channel, and particularly to superimpose the negatively correlated crosstalk canceling signal onto the original audio signal of the other sound channel than the sound channel from which the crosstalk canceling signal is derived, to obtain the play signal of the other sound channel than the sound channel from which the crosstalk canceling signal is derived, or to subtract the crosstalk canceling signal from the original audio signal of the other sound channel than the sound channel from which the crosstalk canceling signal is derived, to obtain the play signal of the other sound channel than the sound channel from which the crosstalk canceling signal is derived (where the signal generator can be a subtracter).

The crosstalk canceling system according to this embodiment will be operated in the same method as the first embodiment, so a repeated description thereof will be omitted here.

In the crosstalk canceling system according to this embodiment, the original audio signal is frequency-divided by the frequency-dividing module 701 into one or more the sub-band signals, then one or more the sub-band signals are delayed, and the gains are applied thereto by the processing module 702, according to the delay values and the gain values corresponding to one or more the sub-band signals, the crosstalk canceling signal is generated by the synthesizing module 703, and further synthesized by the signal generating module 704 with the original audio signal of the other channel, and then the play signal is compensated for the crosstalk, so that the original audio signal corresponding to the other sound channel is heard by the respective ear of the listener, thus canceling the crosstalk in effect.

### Seventh Embodiment

This embodiment provides a crosstalk canceling system. The processing module in the crosstalk canceling system according to the sixth embodiment will be described in further details in this embodiment. This embodiment will be described taking as an example the original audio signal which is an all-frequency signal, that is, the original audio signal includes mid-bass frequencies, and treble frequencies, where the original audio signal is frequency-divided, and delayed, and the gains are applied thereto, so that the crosstalk canceling signal is generated. There are a number of sub-band signals in this embodiment.

The processing module in this embodiment is configured:

To frequency-divide the original audio signal in the sound channel into mid-bass frequency signals at mid-bass frequencies, and treble frequency signals at treble frequencies according to the mid-bass frequencies and the treble frequencies in the original audio signal.

Optionally, more particularly the processing module in this embodiment is configured:

To determine the mid-bass frequencies and the treble frequencies among the frequencies of the original audio signal of the sound channel according to a preset frequency boundary between the mid-bass frequencies and the treble frequencies; and

To divide a signal segment of the original audio signal corresponding to the mid-bass frequencies into at least one mid-bass frequency signal, and a signal segment of the original audio signal corresponding to the treble frequencies into at least one treble frequency signal.

In the crosstalk canceling system according to this embodiment, firstly the original audio signal is frequency-divided by the frequency-dividing module into the respective sub-band signals, then the sub-band signals are delayed, and the gains are applied thereto by the processing module, according to the delay values and the gain values corresponding to the sub-band signals, the crosstalk canceling signal is generated and further synthesized by the synthesizing module with the original audio signal of the other sound source, and then the play signal is compensated for the crosstalk, so that the original audio signal corresponding to the other sound channel is heard by the respective ear of the listener, thus canceling the crosstalk in effect.

### Eighth Embodiment

FIG. 8 is a schematic structural diagram of a sound processing apparatus according to this embodiment. As illustrated in FIG. 8, a sound processing apparatus according to this embodiment includes a plurality of speakers 803, at least one processor 801, and a memory 802 in which at least one instruction executable by the at least one processor is stored. The at least one instruction can be configured:

Upon being executed by the at least one processor 801:

To frequency-divide the original audio signal transmitted over the sound channel into one or more sub-band signals, and to delay and apply gains to one or more the sub-band signals according to preset delay values and gain values corresponding to one or more the sub-band signals;

To generate the crosstalk canceling signal from one or more the sub-band signals which are delayed and to which the gains are applied; and

To synthesize the crosstalk canceling signal, with an original audio signal of another sound channel than the sound channel from which the crosstalk canceling signal is derived, into the play signal of the other sound channel than the sound channel from which the crosstalk canceling signal is derived, and

To output the play signal to the speakers 803.

The at least one instruction can be further configured to make at least two of the delay values different from each other when the sound channel comprises a number of sub-band signals with the corresponding delay values, and the at least one instruction configured to generate the crosstalk canceling signal from one or more the sub-band signals which are delayed and to which the gains are applied is configured:

To synthesize the sub-band signals which are delayed and to which the gains are applied, into the crosstalk canceling signal.

The at least one instruction configured to generate the crosstalk canceling signal from the sub-band signals which are delayed and to which the gains are applied is configured:

To determine one or more the sub-band signals which are delayed and to which the gains are applied, as the crosstalk canceling signals; and

The at least one instruction can be further configured to negatively correlate the generated crosstalk canceling signals.

The at least one instruction configured to synthesize the crosstalk canceling signal, with the original audio signal of the other sound channel than the sound channel from which the crosstalk canceling signal is derived, into the play signal of the other sound channel than the sound channel from which the crosstalk canceling signal is derived is configured:

To generate the play signal of the other sound channel than the sound channel from which the crosstalk canceling signal is derived, corresponding to the sub-band signals from the crosstalk canceling signal, and signals in corresponding frequency bands in the original audio signal of the other sound channel than the sound channel from which the crosstalk canceling signal is derived; and particularly to superimpose the negatively correlated crosstalk canceling signal onto the original audio signal of the other sound channel than the sound channel from which the crosstalk canceling signal is derived, to obtain the play signal of the other sound channel than the sound channel from which the crosstalk canceling signal is derived, or to subtract the crosstalk canceling signal from the original audio signal of the other sound channel than the sound channel from which the crosstalk canceling signal is derived, to obtain the play signal of the other sound channel than the sound channel from which the crosstalk canceling signal is derived.

The at least one instruction configured to delay and apply the gains to the sub-band signals according to the preset delay values and gain values corresponding to the sub-band signals is configured:

To frequency-divide the original audio signal into mid-bass frequency signals at mid-bass frequencies, and treble frequency signals at treble frequencies according to the mid-bass frequencies and the treble frequencies in the original audio signal;

To delay the mid-bass frequency signals according to delay values corresponding to the mid-bass frequencies, and the treble frequency signals according to delay values corresponding to the treble frequencies; and

To apply gains to the mid-bass frequency signals according to gain values corresponding to the mid-bass frequencies, and gains to the treble frequency signals according to gain values corresponding to the treble frequencies.

The at least one instruction configured to frequency-divide the original audio signal according to the mid-bass frequencies and the treble frequencies in the original audio signal is configured:

To determine the mid-bass frequencies and the treble frequencies among the frequencies of the original audio signal of the sound channel according to a preset frequency boundary between the mid-bass frequencies and the treble frequencies; and

To divide a signal segment of the original audio signal corresponding to the mid-bass frequencies into at least one mid-bass frequency signal, and a signal segment of the original audio signal corresponding to the treble frequencies into at least one treble frequency signal.

The crosstalk canceling system according to this embodiment will be operated in the same method as the first embodiment, so a repeated description thereof will be omitted here.

Those ordinarily skilled in the art can appreciate that all or a part of the steps in the methods according to the embodiments described above can be performed by program instructing relevant hardware, where the program can be stored in a computer readable storage medium, and the program can perform one or a combination of the steps in the method embodiments upon being executed; and the storage medium includes an ROM, an RAM, a magnetic disc, an optical disk, or any other medium which can store program codes.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A sound processing apparatus comprising a plurality of speakers, the sound processing apparatus further comprises:
at least one processor, and a memory in which at least one instruction executable by the at least one processor is stored, and the at least one instruction is configured, upon being executed by the at least one processor:
to frequency-divide an original audio signal transmitted over a sound channel of the sound processing apparatus into one or more sub-band signals, and to delay and apply gains to one or more the sub-band signals according to preset delay values and gain values corresponding to one or more the sub-band signals;
to generate the crosstalk canceling signal from one or more the sub-band signals which are delayed and to which the gains are applied;
to generate a play signal of another sound channel of the sound processing apparatus than the sound channel from which the crosstalk canceling signal is derived, according to the crosstalk canceling signal, and an original audio signal of the another sound channel than the sound channel from which the crosstalk canceling signal is derived; and
to output the play signal the speakers.

2. The sound processing apparatus according to claim 1, wherein the at least one instruction is further configured upon being executed by the at least one processor to make at least two of the delay values different from each other when the sound channel comprises a plurality of sub-band signals with the corresponding delay values, and the at least one instruction configured to generate the crosstalk canceling signal from one or more the sub-band signals which are delayed and to which the gains are applied is configured:
to synthesize the sub-band signals which are delayed and to which the gains are applied, into the crosstalk canceling signal.

3. The sound processing apparatus according to claim 1, wherein the at least one instruction configured to generate the crosstalk canceling signal from one or more the sub-band signals which are delayed and to which the gains are applied is configured:
to determine one or more the sub-band signals which are delayed and to which the gains are applied, as the crosstalk canceling signals.

4. The sound processing apparatus according to claim 1, wherein the at least one instruction is further configured to negatively correlate the crosstalk canceling signal after generating the crosstalk canceling signal; and the at least one instruction configured to generate the play signal of the another sound channel than the sound channel from which the crosstalk canceling signal is derived, from the crosstalk canceling signal, and the original audio signal of the another sound channel than the sound channel from which the crosstalk canceling signal is derived, is configured:
to superimpose the negatively correlated crosstalk canceling signal onto the original audio signal of the another sound channel than the sound channel from which the crosstalk canceling signal is derived, to obtain the play signal of the another sound channel than the sound channel from which the crosstalk canceling signal is derived.

5. The sound processing apparatus according to claim 1, wherein the at least one instruction configured to generate the play signal of the another sound channel than the sound channel from which the crosstalk canceling signal is derived, according to the crosstalk canceling signal, and the original audio signal of the another sound channel than the sound channel from which the crosstalk canceling signal is derived, is configured:
to subtract the crosstalk canceling signal from the original audio signal of the another sound channel than the sound channel from which the crosstalk canceling signal is derived, to obtain the play signal of the another sound channel than the sound channel from which the crosstalk canceling signal is derived.

6. The sound processing apparatus according to claim 1, wherein the at least one instruction configured to delay and apply the gains to one or more the sub-band signals according to the preset delay values and gain values corresponding to the sub-band signals is configured:
to frequency-divide the original audio signal into mid-bass frequency signals at mid-bass frequencies, and treble frequency signals at treble frequencies according to mid-bass frequencies and treble frequencies in the original audio signal;
to delay the mid-bass frequency signals according to delay values corresponding to the mid-bass frequencies, and the treble frequency signals according to delay values corresponding to the treble frequencies; and
to apply gains to the mid-bass frequency signals according to gain values corresponding to the mid-bass frequencies, and gains to the treble frequency signals according to gain values corresponding to the treble frequencies.

7. The sound processing apparatus according to claim 6, wherein the at least one instruction configured to frequency-divide the original audio signal according to the mid-bass frequencies and the treble frequencies in the original audio signal is configured:
to determine the mid-bass frequencies and the treble frequencies among the frequencies of the original audio signal of the sound channel according to a preset frequency boundary between the mid-bass frequencies and the treble frequencies; and
to divide a signal segment of the original audio signal corresponding to the mid-bass frequencies into at least one mid-bass frequency signal, and a signal segment of the original audio signal corresponding to the treble frequencies into at least one treble frequency signal.

8. A crosstalk canceling system applicable to a multimedia device, the crosstalk canceling system comprising:
a sub-band filter component configured to frequency-divide an original audio signal transmitted over a sound channel of the multimedia device into one or more sub-band signals, and to delay and apply gains to the sub-band signals according to preset delay values and gain values corresponding to one or more the sub-band signals;
a synthesizer configured to generate a crosstalk canceling signal from one or more the sub-band signals which are delayed and to which the gains are applied; and
a signal generator configured to generate a play signal of another sound channel than the sound channel from which the crosstalk canceling signal is derived, according to the crosstalk canceling signal, and an original audio signal of the another sound channel than the sound channel from which the crosstalk canceling signal is derived.

9. The crosstalk canceling system according to claim 8, wherein when the sub-band filter component comprises a plurality of sub-band filters with corresponding delay values, at least two of which are different from each other; and the synthesizer configured to generate the crosstalk canceling signal from the sub-band signals which are delayed and to which the gains are applied is configured:
to synthesize the sub-band signals which are delayed and to which the gains are applied, into the crosstalk canceling signal.

10. The crosstalk canceling system according to claim 8, wherein the synthesizer configured to generate the crosstalk canceling signal from one or more the sub-band signals which are delayed and to which the gains are applied is configured:
to determine one or more the sub-band signals which are delayed and to which the gains are applied, as the crosstalk canceling signals.

11. The crosstalk canceling system according to claim 8, wherein the synthesizer is further configured to negatively correlate the crosstalk canceling signal after generating the crosstalk canceling signal; and the signal generator configured to generate the play signal of the another sound channel than the sound channel from which the crosstalk canceling signal is derived, according to the crosstalk canceling signal, and the original audio signal of the another sound channel than the sound channel from which the crosstalk canceling signal is derived is configured to superimpose the negatively correlated crosstalk canceling signal onto the original audio signal of the another channel than the sound channel from which the crosstalk canceling signal is derived, to obtain the play signal of the another sound channel than the sound channel from which the crosstalk canceling signal is derived.

12. The crosstalk canceling system according to claim 8, wherein the signal generator configured to generate the play signal of the another sound channel than the sound channel from which the crosstalk canceling signal is derived, according to the crosstalk canceling signal, and the original audio signal of the another sound channel than the sound channel from which the crosstalk canceling signal is derived, is configured to subtract the crosstalk canceling signal from the original audio signal of the another sound channel than the sound channel from which the crosstalk canceling signal is derived, to obtain the play signal of the another sound channel than the sound channel from which the crosstalk canceling signal is derived.

13. The crosstalk canceling system according to claim 8, wherein when the sub-band filter component comprises a plurality of sub-band filters, and each of the sub-band filters comprise:
analysis filters configured to frequency-divide the original audio signal into mid-bass frequency signals at mid-bass frequencies, and high frequency signals at treble frequencies according to mid-bass frequencies and treble frequencies in the original audio signal;
delay processors connected with the analysis filters, configured to delay the mid-bass frequency signals according to delay values corresponding to the mid-bass frequencies, and delay the treble frequency signals according to delay values corresponding to the treble frequencies; and
gain processors connected respectively with the synthesizer and the delay processors, configured to apply gains to the mid-bass frequency signals according to gain values corresponding to the mid-bass frequencies, and apply gains to the treble frequency signals according to gain values corresponding to the treble frequencies.

14. The crosstalk canceling system according to claim 13, wherein the analysis filters configured to frequency-divide the original audio signal according to the mid-bass frequencies and the treble frequencies in the original audio signal is configured:
to determine the mid-bass frequencies and the treble frequencies among the frequencies of the original audio signal according to a preset frequency boundary between the mid-bass frequencies and the treble frequencies; and
to divide a signal segment of the original audio signal corresponding to the mid-bass frequencies into at least one mid-bass frequency signal, and divide a signal segment of the original audio signal corresponding to the treble frequencies into at least one treble frequency signal.

15. A crosstalk canceling method applicable to a multimedia device comprising a sound processing apparatus and a number of speakers, the crosstalk canceling method comprises:
frequency-dividing, by the sound processing apparatus, an original audio signal transmitted over a sound channel of the speakers into one or more sub-band signals of the original audio signal in the sound channel;
delaying and applying gains, by the sound processing apparatus, to one or more the sub-band signals according to preset delay values and gain values corresponding to the sub-band signals; and
generating, by the sound processing apparatus, a crosstalk canceling signal of the sound channel from one or more the sub-band signals which are delayed and to which the gains are applied, and generating a play signal of another sound channel than the sound channel from which the crosstalk canceling signal is derived, according to the crosstalk canceling signal, and an original audio signal of the another sound channel than the sound channel from which the crosstalk canceling signal is derived.

16. The crosstalk canceling method according to claim 15, wherein when the sound channel comprises a plurality of sub-band signals with the corresponding delay values, at least two of which are different from each other, and the generating the crosstalk canceling signal from the sub-band signals which are delayed and to which the gains are applied comprises:
synthesizing the sub-band signals which are delayed and to which the gains are applied, into the crosstalk canceling signal.

17. The crosstalk canceling method according to claim 15, wherein the generating the crosstalk canceling signal from one or more the sub-band signals which are delayed and to which the gains are applied comprises:
determining one or more the sub-band signals which are delayed and to which the gains are applied, as the crosstalk canceling signals.

18. The crosstalk canceling method according to claim 15, wherein after the sound processing apparatus generates the crosstalk canceling signal of the sound channel from the sub-band signals which are delayed and to which the gains are applied, the method further comprises:
negatively correlating, by the sound processing apparatus, the crosstalk canceling signal; and
the generating the play signal of the another sound channel than the sound channel from which the crosstalk canceling signal is derived, according to the crosstalk canceling signal, and the original audio signal of the another sound channel than the sound channel from which the crosstalk canceling signal is derived comprises:
superimposing the negatively correlated crosstalk canceling signal onto the original audio signal of the another sound channel than the sound channel from which the crosstalk canceling signal is derived, to generate the play signal of the another sound channel than the sound channel from which the crosstalk canceling signal is derived.

19. The crosstalk canceling method according to claim 15, wherein the generating the play signal of the another sound channel than the sound channel from which the crosstalk canceling signal is derived, from the crosstalk canceling signal, and the original audio signal of the another sound channel than the sound channel from which the crosstalk canceling signal is derived comprises:
subtracting the crosstalk canceling signal from the original audio signal of the another sound channel than the sound channel from which the crosstalk canceling signal is derived, to generate the play signal of the another sound channel than the sound channel from which the crosstalk canceling signal is derived.

20. The crosstalk canceling method according to claim 15, wherein the frequency-dividing the original audio signal in the sound channel into the sub-band signals comprises:
frequency-dividing the original audio signal in the sound channel into mid-bass frequency signals at mid-bass frequencies, and treble frequency signals at treble frequencies according to mid-bass frequencies and treble frequencies in the original audio signal; and
wherein the frequency-dividing the original audio signal in the sound channel into the mid-bass frequency signals at the mid-bass frequencies, and the treble frequency signals at the treble frequencies according to the mid-bass frequencies and the treble frequencies in the original audio signal comprises:
determining the mid-bass frequencies and the treble frequencies among the frequencies of the original audio signal according to a preset frequency boundary between the mid-bass frequencies and the treble frequencies; and
dividing a signal segment of the original audio signal corresponding to the mid-bass frequencies into at least one mid-bass frequency signal, and a signal segment of the original audio signal corresponding to the treble frequencies into at least one treble frequency signal.
